(19) United States
(12) Patent Application Publication
(10) Pub. No.: US 2008/0312788 A1
(43) Pub. Date: Dec. 18, 2008

(54) METHOD AND SYSTEM FOR IDENTIFYING OCCUPANTS OF VEHICLES

(75) Inventors: Gurpreet Aulakh, Brownstown Township, MI (US); Ronald Hugh Miller, Saline, MI (US); Aric David Shaffer, Ypsilanti, MI (US); Dumitru Raceu, Warren, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/761,574

(22) Filed: Jun. 12, 2007

(51) Int. Cl. G06F 13/00

(52) U.S. Cl. 701/36; 701/213

(57) ABSTRACT

Signals indicative of the identity and location of vehicle occupants are broadcast and received. Received signals are inspected for identity information. Indications are made as to whether received identity information matches stored identity information.

### BACKGROUND

1. Field of the Invention

The invention relates to methods and systems for identifying occupants of vehicles.

2. Discussion

A driver of a vehicle may wish to communicate with friends and family in other vehicles in the vicinity. The driver, however, may be unaware that his friends or family occupy vehicles in the vicinity.

### SUMMARY

Embodiments of the invention may take the form of a method of identifying, in a first vehicle, an occupant of a second vehicle. The method includes receiving input defining acquaintances of a first occupant of the first vehicle and receiving information from the second vehicle identifying a second occupant of the second vehicle. The method also includes determining whether the second occupant is an acquaintance of the first occupant and indicating whether the second occupant is an acquaintance of the first occupant.

Embodiments of the invention may take the form of a method of establishing communications between a first occupant in a first vehicle and a second occupant in a second vehicle. The method includes transmitting information identifying the first occupant and receiving a message from the second vehicle to alert the first vehicle that the second vehicle is in a predefined geographic region relative to the first vehicle. The method also includes establishing a line of communication with the occupant of the second vehicle.

Embodiments of the invention may take the form of a system for identifying, in a first vehicle, an occupant of a second vehicle. The system includes an input module configured to receive input defining acquaintances of a first occupant of the first vehicle. The system also includes a locator module configured to send information identifying the first occupant and receive information from the second vehicle identifying a second occupant of the second vehicle. The system further includes a processing module configured to determine whether the second occupant is an acquaintance of the first occupant and indicate whether the second occupant is an acquaintance of the first occupant.

### BRIEF DESCRIPTION OF THE DRAWINGS

FIG. 1 is a schematic diagram of a system for identifying occupants of vehicles in accordance with an embodiment of the invention.

FIG. 2 is a schematic diagram of the application processing board of FIG. 1.

FIG. 3 is schematic diagram of several vehicles in proximity to each other.

FIG. 4 is a flow chart of a method for establishing communications between occupants of vehicles.

FIG. 5 is another flow chart of a method for establishing communications between occupants of vehicles.

### DETAILED DESCRIPTION

Embodiments of the invention may provide a system for monitoring and detecting vehicles being driven by acquaintances. This system may be integrated with the vehicle communication system or may be a self contained unit.

Embodiments of the invention may provide application processors that may include wireless modems and USB and Serial ports for data transfer. The USB and Serial ports may be accessible from the instrument panel.

In some embodiments a user, e.g., a driver of a vehicle, may download his member list, including names and corresponding contact information, from a computer to a memory device, e.g., memory card. The driver may then upload this list to his car via USB or Serial port, or via wireless.

In some embodiments, wireless chipsets transmit signals including identification and vehicle location information. For example, when the driver is driving his car, a wireless chipset in his vehicle may detect other vehicle-based wireless chipsets of friends or family based on the received signals and member list. If detected, the driver may be notified that a friend or family member is in relatively close proximity, e.g., 5 miles. This allows vehicle occupants to identify each other thus facilitating communication, e.g., text/instant messaging, phone calls, etc., between vehicles.

In some embodiments, if an occupant of a proximate vehicle is recognized, the name and phone number of that occupant, as well as vehicle location information, may be displayed. The driver may then initiate communication with the occupant of the proximate vehicle.

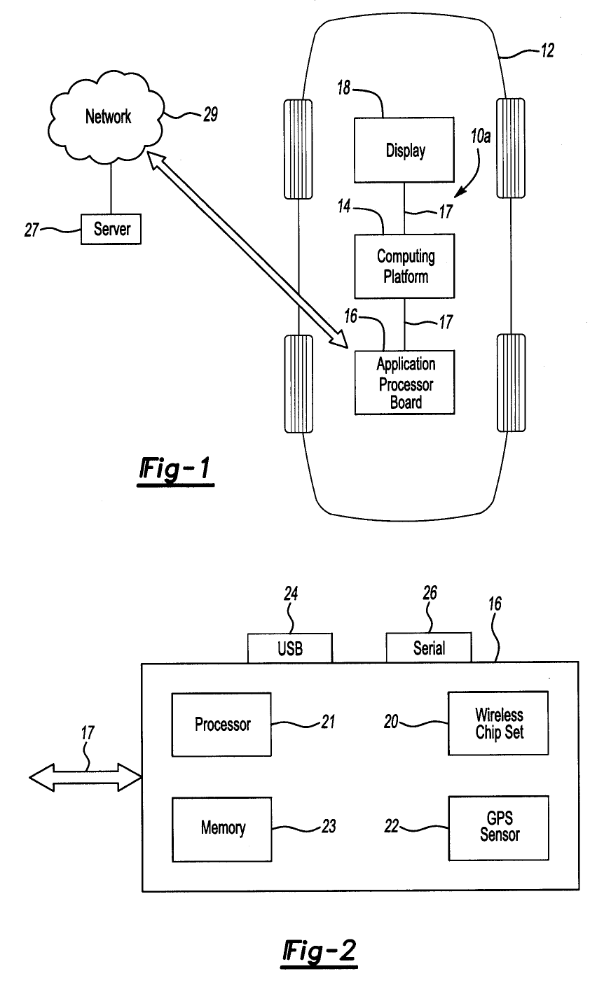

FIG. 1 is a schematic diagram of a system for identifying occupants of vehicles. System 10a includes computing platform 14, e.g., a central processing unit, application processing board (APB) 16, and display 18, e.g., monitor. Computing platform 14 communicates with application processing board 16 and display 18 via a car area network (CAN) 17. In alternative embodiments, a computing platform may communicate with an APB and a display via hard wire or wireless.

As explained below, system 10a broadcasts signatures indicative of the identity of an occupant of vehicle 12 and the location of vehicle 12 and receives signatures indicative of identities of occupants of other vehicles and locations of these other vehicles.

FIG. 2 is a schematic diagram of the application processing board of FIG. 1. APB 16 of FIG. 2 includes wireless chip set 20, miro processor 21, GPS sensor 22, memory 23, USB port 24, and serial port 26. APB 16 communicates with other components of vehicle 12, e.g., computing platform 14, via CAN 17. APB 16 provides and receives data via USB port 24 and serial port 26. APB 16 also provides and receives data via wireless chip set 20. In alternative embodiments, an APB may or may not include some of the elements, e.g., memory 23, etc., described above.

Wireless chip set 20 of FIG. 2 includes circuitry capable of producing a broadcast signature for an occupant of vehicle 12. This signature includes information as to the identity of the occupant as well as location information for vehicle 12 gathered by, for example, GPS sensor 22. Wireless chip set 20 also includes circuitry capable of detecting signatures broadcast by APBs from other vehicles. Such signals may be detected, interpreted, and communicated to computing platform 14 for further processing. As described below, computing platform 14 may then determine whether a signature received is from a vehicle containing a person known by the occupant of vehicle 12.

In the embodiment of FIG. 2, the information identifying the occupant of vehicle 12 and the friends and family of the occupant of vehicle 12 may be uploaded to system 10a via wireless chip set 20, USB port 24, or serial port 26. For example, APB 16 may establish communications with server 27 (FIG. 1) via network 29 (FIG. 1) to gather friends and family information from server 27. This information may include names and corresponding contact addresses. Once uploaded, an occupant may notify system 10a of their desire to communicate with others by, for example, selecting their identity information from display 18.

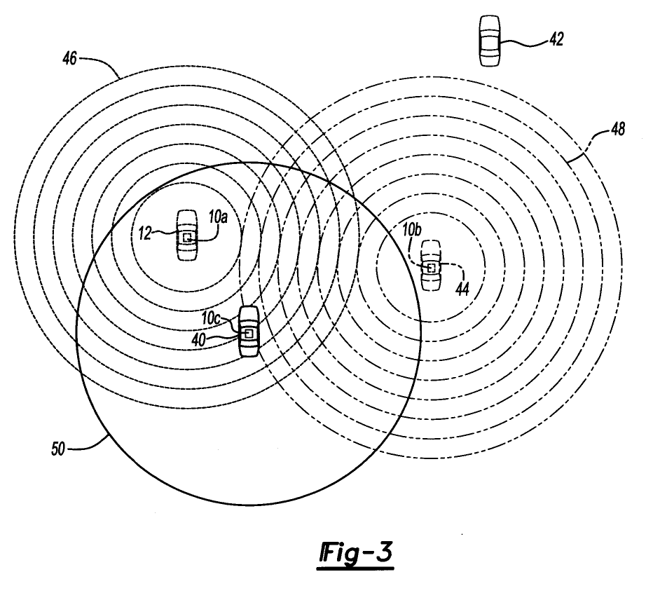

FIG. 3 is schematic diagram of several vehicles in proximity to each other. Systems 10a, 10b of vehicles 12, 44 are broadcasting signatures 46, 48 respectively. Signatures 46, 48 of FIG. 3 are indicative of the identities of the occupants of each respective vehicle as well as the respective geographic locations of vehicles 12, 44. System 10c of vehicle 40 is listening for signatures indicative of acquaintances of the occupant of vehicle 40.

The occupant of vehicle 40 may input to system 10c a predetermined geographic region in which he is interested in identifying other vehicles transporting persons known by the occupant of vehicle 40. In the embodiment of FIG. 3, this region is defined by circular region 50, whose center coincides with the location of vehicle 40. In some alternative embodiments, region 50 may have a different shape or may be a predefined geographic region, e.g., a city, through which the occupant of vehicle 40 knows they will be traveling. In other alternative embodiments, the occupant of vehicle 40 does not input to system 10c such a predetermined geographic region. In these and similar embodiments, the signal strength associated with transmitted and received signatures determines the effective range of system 10c.

In the instant example, the wireless chipset of system 10c detects signatures 46, 48. Detected signatures 46, 48 are communicated to the computing platform of system 10c. Identity information from signatures 46, 48 is compared to the friends and family information of the occupant stored by system 10c. In this example, each of vehicles 12, 44 contain a friend of the occupant of vehicle 40 and thus, signatures 46, 48 are recognized by system 10c.

In the embodiment of FIG. 3, vehicle location information from signatures 46, 48 is used to determine whether vehicles 12, 44 fall within region 50. In the instant example, vehicle 12 falls within region 50, and, as such, system 10c may display the location of vehicle 12 on a display screen. Additionally, system 10c may prompt the occupant, via, for example, voice or display screen, to initiate communications with the occupant of vehicle 12.

In the embodiment of FIG. 3, if the occupant of vehicle 40 responds to the prompt, system 10c initiates, via the wireless chipset of system 10c, a preliminary communication request, e.g., a message notifying vehicle 12 of the desire of the occupant of vehicle 40 to communicate with the occupant of vehicle 12. Upon receiving such request, system 10a of vehicle 12 may notify the occupant of vehicle 12 of the pending communication request. The occupant of vehicle 12 may provide input, via, for example, voice or tactile commands, to system 10a to accept the request via, for example, a response message. A line of communication may then be opened, e.g., the first occupant may call the second occupant.

In the embodiment of FIG. 3, vehicle 44 falls outside region 50 and, as such, system 10c may not notify the occupant of vehicle 40 regarding the occupants or whereabouts of vehicle 44.

In alternative embodiments, system 10c may prompt the occupant as to which form of communication, e.g., instant messaging, telephone call, EPC, the occupant would like to initiate with vehicle 12.

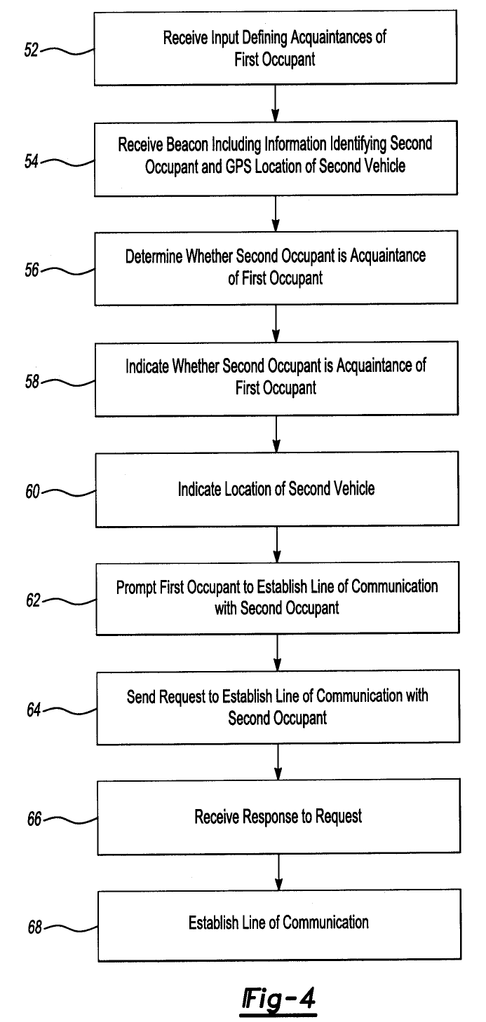

FIG. 4 is a flow chart of a method for establishing communications between occupants of vehicles. At 52, input defining acquaintances of the first occupant is received. At 54, a beacon including information identifying a second occupant of a second vehicle and a GPS location of the second vehicle is received. At 56, whether the second occupant is an acquaintance of the first occupant is determined based on the information identifying the second occupant and the defined acquaintances, e.g., identity information of the second occupant is compared to a stored acquaintance list. At 58, whether the second occupant is an acquaintance of the first occupant is indicated, e.g., the name of the second occupant is announced if the second occupant is an acquaintance of the first occupant. At 60, the location of the second vehicle is indicated, e.g., the location of the second vehicle is displayed on a display screen. At 62, the first occupant is prompted to establish a line of communication with the second occupant. At 64, a request to establish a line of communication with the second occupant is sent. At 66, a response to the request is received. At 68, a line of communication is established.

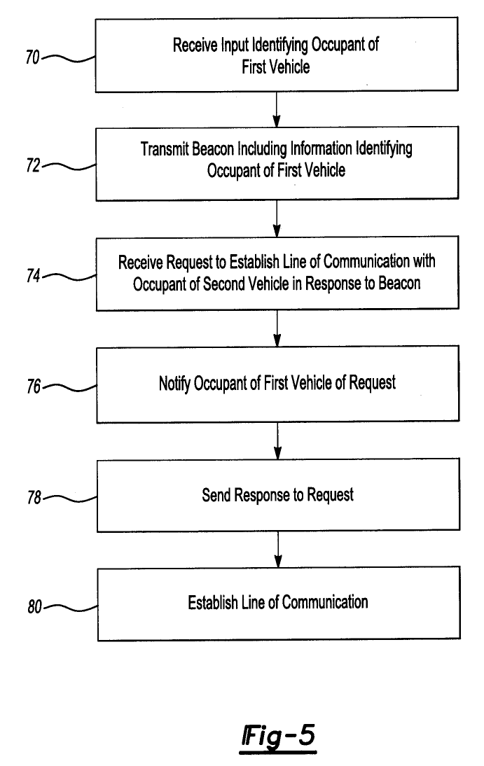

FIG. 5 is another flow chart of a method for establishing communications between occupants of vehicles. At 70, input identifying an occupant of the first vehicle is received. At 72, a beacon including information identifying an occupant of the first vehicle is transmitted. At 74, a request, e.g., a message indicating that a recognized second vehicle is within range of the first vehicle, to establish a line of communication with the occupant of the second vehicle is received in response to the beacon. At 76, the occupant of the first vehicle is notified of the request. At 78, a response to the request is sent. At 80, a line of communication is established.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of identifying, in a first vehicle, an occupant of a second vehicle, the method comprising:
receiving input defining acquaintances of a first occupant of the first vehicle;
receiving information from the second vehicle identifying a second occupant of the second vehicle;
determining whether the second occupant is an acquaintance of the first occupant based on the information identifying the second occupant and the defined acquaintances; and
indicating whether the second occupant is an acquaintance of the first occupant, thereby identifying, in the first vehicle, the occupant of the second vehicle.

2. The method of claim 1 further comprising prompting the first occupant to establish a line of communication with the second occupant.

3. The method of claim 1 further comprising sending a request to the second vehicle to establish a line of communication with the second occupant.

4. The method of claim 3 further comprising receiving a response to the request to establish a line of communication with the second vehicle.

5. The method of claim 1 further comprising receiving information from the second vehicle identifying a location of the second vehicle.

6. The method of claim 5 wherein the information identifying the location of the second vehicle comprises geographic coordinate data.

7. The method of claim 6 wherein the geographic coordinate data comprises global positioning satellite data.

8. The method of claim 5 further comprising indicating the location of the second vehicle.

9. The method of claim 1 wherein the input defining acquaintances of the first occupant is received via a wireless transmission.

10. A method of establishing communications between a first occupant in a first vehicle and a second occupant in a second vehicle, the method comprising:
transmitting information identifying the first occupant;
receiving a message from the second vehicle to alert the first vehicle that the second vehicle is in a predefined geographic region relative to the first vehicle; and
establishing a line of communication with the occupant of the second vehicle.

11. The method of claim 10 wherein the predefined geographic region is defined by a predetermined distance from the first vehicle.

12. The method of claim 10 further comprising transmitting information identifying a location of the first vehicle.

13. The method of claim 12 wherein the information identifying the location of the first vehicle comprises geographic coordinate data.

14. The method of claim 13 wherein the geographic coordinate data comprises global positioning satellite data.

15. A system for identifying, in a first vehicle, an occupant of a second vehicle, the system comprising:
an input module configured to receive input defining acquaintances of a first occupant of the first vehicle;
a locator module configured to
send information identifying the first occupant, and
receive information from the second vehicle identifying a second occupant of the second vehicle; and
a processing module configured to
determine whether the second occupant is an acquaintance of the first occupant based on the information identifying the second occupant and the defined acquaintances, and
indicate whether the second occupant is an acquaintance of the first occupant, thereby identifying, in the first vehicle, the occupant of the second vehicle.

16. The system of claim 15 wherein the processing module is further configured to prompt the first occupant to establish a line of communication with the second occupant.

17. The system of claim 15 wherein the locator module is further configured to send a request to the second vehicle to establish a line of communication with the second occupant.

18. The system of claim 17 wherein the locator module is further configured to receive a response to the request to establish a line of communication with the second vehicle.

19. The system of claim 15 wherein the locator module is further configured to receive information from the second vehicle identifying a location of the second vehicle and wherein the processing module is further configured to indicate the location of the second vehicle.

20. The system of claim 15 wherein the input defining acquaintances of the first occupant is received via a wireless transmission.
